(19) United States
(12) Patent Application Publication
(10) Pub. No.: US 2025/0346287 A1
(43) Pub. Date: Nov. 13, 2025

(54) STEER BY WIRE TYPE STEERING APPARATUS

(71) Applicant: HL MANDO CORPORATION, Gyeonggi-do (KR)

(72) Inventor: Hyunbi KWON, Gyeonggi-do (KR)

(21) Appl. No.: 19/193,951

(22) Filed: Apr. 29, 2025

(30) Foreign Application Priority Data
May 8, 2024 (KR) 10-2024-0060247

(51) Int. Cl. B62D 5/00

(52) U.S. Cl. CPC B62D 5/001

(57) ABSTRACT

According to the present embodiments, it is possible to provide a steer by wire type steering apparatus capable of improving a steering feel and steering stability of a driver by mechanically preventing a steering wheel from rotating any further in a case where rotation of the wheel reaches the maximum point.

### CROSS-REFERENCE TO RELATED APPLICATIONS

This application claims the priority of Korean Patent Application No. 10-2024-0060247 filed on May 8, 2024, in the Korean Intellectual Property Office, the disclosure of which is incorporated herein by reference.

### BACKGROUND

### Field

The present embodiments relate to a steer by wire type steering apparatus, and more specifically, to a steer by wire type steering apparatus capable of mechanically preventing a steering wheel from rotating any further in a case where the rotation of wheels in the steer by wire type steering apparatus reaches a maximum point.

### Description of the Related Art

In general, a steering apparatus of a vehicle has been developed and applied with power steering to assist a steering wheel operation force of a driver and provide convenience in driving operation, and the power steering has been developed and applied in the form of hydraulic type that uses hydraulic pressure, electro-hydraulic type that uses hydraulic pressure and electric power of a motor simultaneously, and electric type that uses only electric power of a motor.

Recently, a steer by wire (SBW) type steering apparatus has been developed and applied that uses an electric motor, such as a motor, to steer the vehicle instead of removing mechanical connecting devices such as a steering column, universal joint, or pinion shaft between the steering wheel and wheels.

However, in the case of the steer by wire type steering apparatus, since there is no mechanical connection between the steering shaft and the wheels, there is a problem that the steering wheel of the driver can rotate indefinitely, which reduces a steering feel and steering stability of the driver.

Therefore, there is a growing need for research to prevent the steering wheel from rotating any further in a case where the wheel rotation reaches the maximum point thereof (in a case where the steering wheel or wheel is in a full-turn state in a typical steering apparatus).

### SUMMARY

Accordingly, the present embodiments have been devised in consideration of the background described above, and an object thereof is to provide a steer by wire type steering apparatus capable of improving a steering feel and steering stability of a driver by mechanically preventing the steering wheel from rotating any further in a case where rotation of the wheel in the steer by wire type steering apparatus reaches the maximum point.

Furthermore, objects of the present embodiments are not limited thereto, and other objects not mentioned will be clearly understood by those skilled in the art from the description below.

According to the present embodiments, there is provided a steer by wire type steering apparatus including: a first rotating ring member that is coupled to a steering shaft and rotates in conjunction with the steering shaft; a second rotating ring member that is coupled to the steering shaft and supported by one end portion of the first rotating ring member in a case where the steering shaft rotates, and rotates in conjunction with the first rotating ring member; a housing that is provided with an arc-shaped guide groove centered on the steering shaft and a stopper partition that connects radially inner and outer surfaces of the guide groove; and a stopper member that is coupled to the guide groove and is supported by one end portion of the second rotating ring member and rotates in a case where the steering shaft rotates.

In addition, according to the present embodiments, there is provided a steer by wire type steering apparatus including: a first rotating ring member that is coupled to a steering shaft and rotates in conjunction with the steering shaft; a second rotating ring member that is coupled to the steering shaft and supported by one end portion of the first rotating ring member in a case where the steering shaft rotates, and rotates in conjunction with the first rotating ring member; a housing that is provided with an arc-shaped stepped groove centered on the steering shaft and a stopper partition that connects radially inner and outer surfaces of the stepped groove; a guide member that is formed in an arc shape and has one end and the other end supporting both surfaces of the stopper partition and is coupled to the stepped groove; and a stopper member that is coupled to the guide member and is supported by one end portion of the second rotating ring member and rotates in a case where the steering shaft rotates.

According to these embodiments, in a case where the rotation of the wheel in the steer by wire type steering apparatus reaches the maximum point, the steering wheel is mechanically prevented from rotating any further, thereby improving the steering feel and steering safety of a driver.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a schematic diagram illustrating a steer by wire type steering apparatus according to the present embodiments;

FIG. 2 is a perspective view illustrating a part of the steer by wire type steering apparatus according to the present embodiments;

FIGS. 3 and 4 are exploded perspective views illustrating a part of the steer by wire type steering apparatus according to the present embodiments;

FIGS. 5 to 8 are perspective views illustrating a part of the steer by wire type steering apparatus according to the present embodiments;

FIG. 9 is a cross-sectional view illustrating a part of the steer by wire type steering apparatus according to the present embodiments;

FIG. 10 is a perspective view illustrating a part of the steer by wire type steering apparatus according to the present embodiments;

FIG. 11 is an exploded perspective view illustrating a part of the steer by wire type steering apparatus according to the present embodiments;

FIG. 12 is a perspective view illustrating a part of the steer by wire type steering apparatus according to the present embodiments; and

FIG. 13 is a cross-sectional view illustrating a part of the steer by wire type steering apparatus according to the present embodiments.

### DETAILED DESCRIPTION OF THE EMBODIMENT

In the following description of examples or embodiments of the present disclosure, reference will be made to the accompanying drawings in which it is illustrated by way of illustration specific examples or embodiments that can be implemented, and in which the same reference numerals and signs can be used to designate the same or like components even when they are illustrated in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements or the like, but is used merely to distinguish the corresponding element from other elements.

When it is mentioned that a first element “is connected or coupled to”, “contacts or overlaps” or the like a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, or the like each other via a fourth element. Here, the second element may be included in at least one of two or more elements that “are connected or coupled to”, “contact or overlap”, or the like each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes or the like are mentioned, it should be considered that numerical values for an elements or features, or corresponding information (for example, level, range, or the like) include a tolerance or error range that may be caused by various factors (for example, process factors, internal or external impact, noise, or the like) even when a relevant description is not specified. Further, the term “may” fully encompass all the meanings of the term “can”.

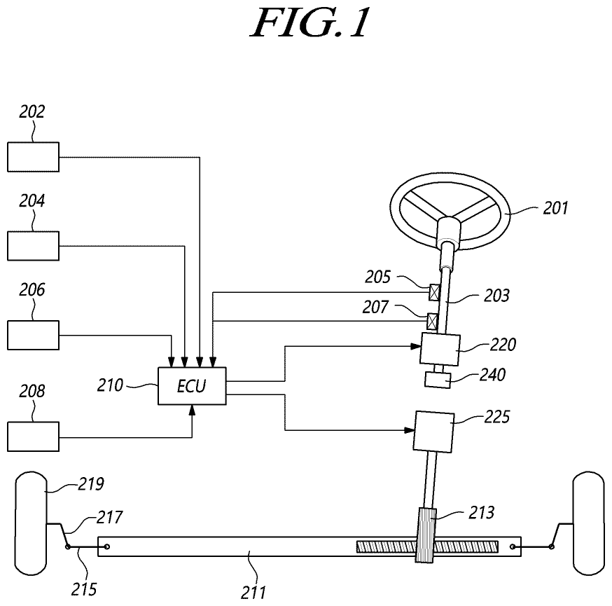

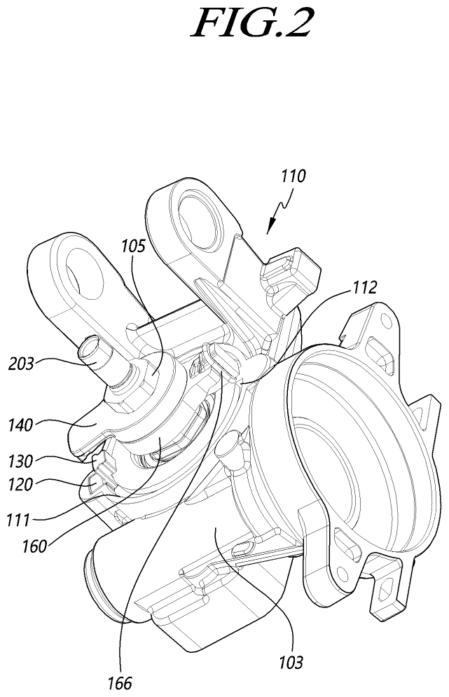

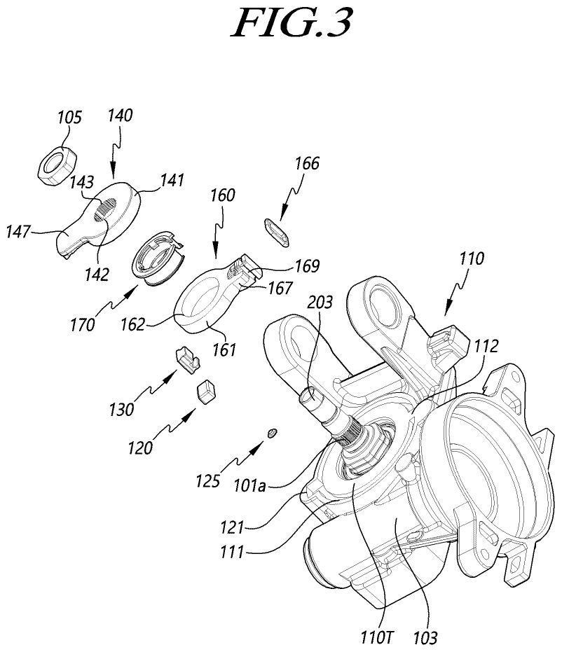

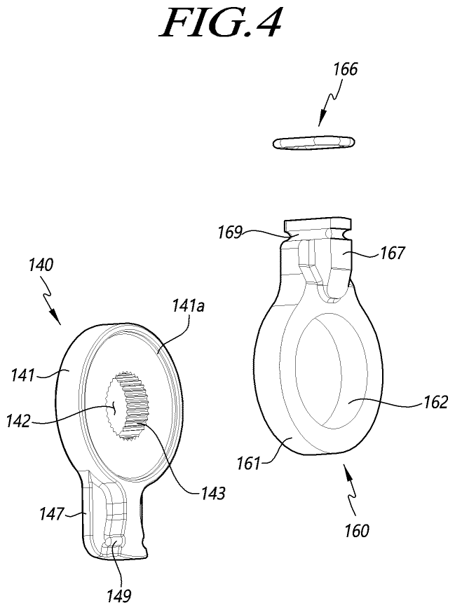

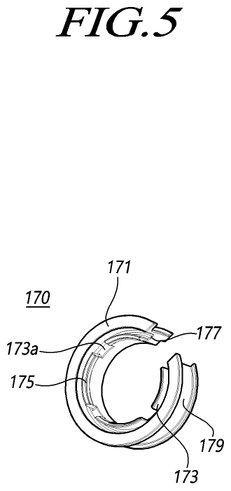

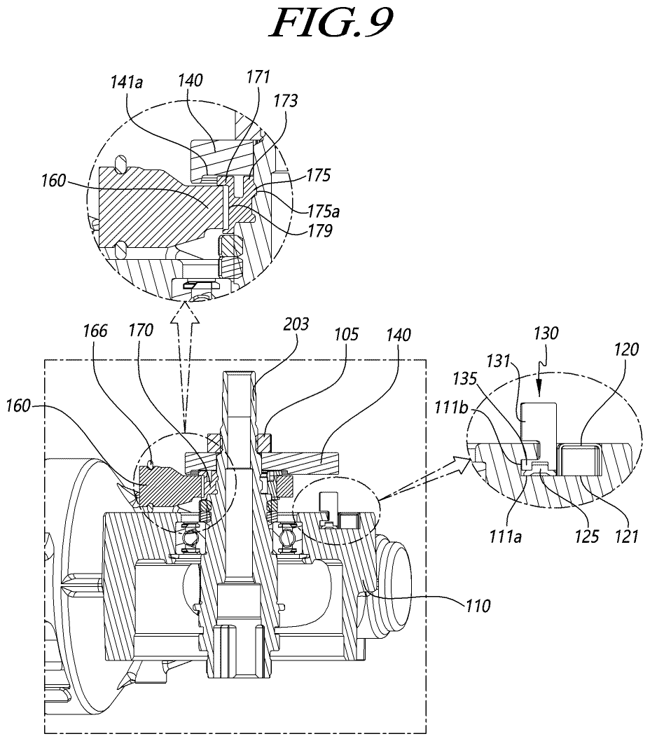

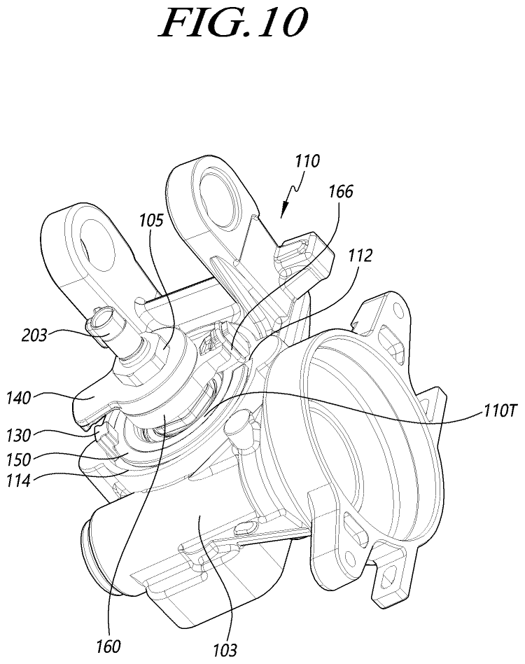

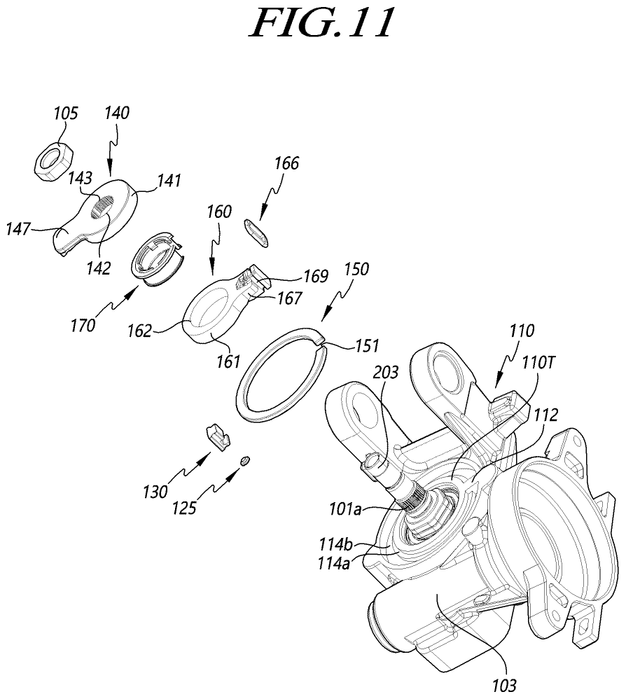

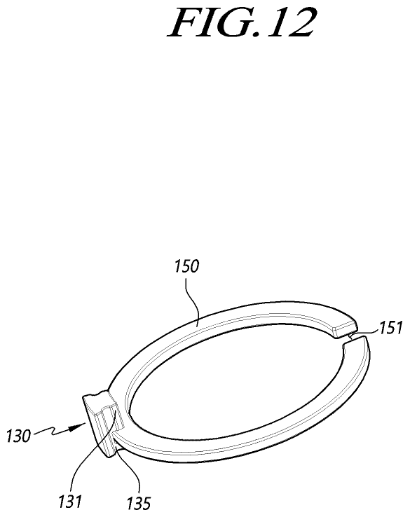

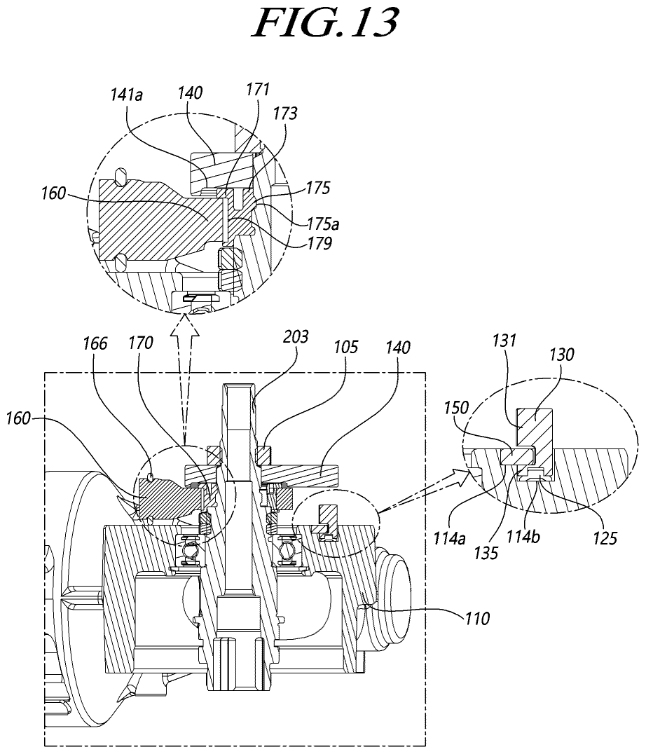

FIG. 1 is a schematic diagram illustrating a steer by wire type steering apparatus according to the present embodiments, FIG. 2 is a perspective view illustrating a part of the steer by wire type steering apparatus according to the present embodiments, FIGS. 3 and 4 are exploded perspective views illustrating a part of the steer by wire type steering apparatus according to the present embodiments, FIGS. 5 to 8 are perspective views illustrating a part of the steer by wire type steering apparatus according to the present embodiments, FIG. 9 is a cross-sectional view illustrating a part of the steer by wire type steering apparatus according to the present embodiments, FIG. 10 is a perspective view illustrating a part of the steer by wire type steering apparatus according to the present embodiments, FIG. 11 is an exploded perspective view illustrating a part of the steer by wire type steering apparatus according to the present embodiments, FIG. 12 is a perspective view illustrating a part of the steer by wire type steering apparatus according to the present embodiments, and FIG. 13 is a cross-sectional view illustrating a part of the steer by wire type steering apparatus according to the present embodiments.

First, referring to FIGS. 1 to 9, the steer by wire type steering apparatus according to the present embodiments includes a first rotating ring member 140 that is coupled to a steering shaft 203 and rotates in conjunction with the steering shaft 203, a second rotating ring member 160 that is coupled to the steering shaft 203 and supported by one end portion of the first rotating ring member 140 in a case where the steering shaft 203 rotates and rotates in conjunction with the first rotating ring member 140, a housing 110 that is provided with an arc-shaped guide groove 111 centered on the steering shaft 203 and a stopper partition 112 connecting the radially inner and outer surfaces of the guide groove 111, and a stopper member 130 that is coupled to the guide groove 111 and is supported by one end portion of the second rotating ring member 160 and rotate in a case where the steering shaft 203 rotates.

First, referring to FIG. 1, the steer by wire type steering apparatus according to the present embodiments has an angle sensor 205 and a torque sensor 207 coupled to one side of the steering shaft 203 connected to a steering wheel 201, and in a case where a driver operates the steering wheel 201, the angle sensor 205 and the torque sensor 207 detect the operation and send an electric signal to an electronic control device 210 so that a steering shaft motor 220 and a pinion shaft motor 225 are operated.

The electronic control device 210 controls the steering shaft motor 220 and the pinion shaft motor 225 based on the electric signals transmitted from the angle sensor 205 and the torque sensor 207 and other electric signals transmitted from various sensors mounted on the vehicle.

The steering shaft motor 220 is connected to a reducer (see 103 in FIG. 2) that reduces the rotational speed of the motor, and during normal driving, a reaction force is provided to the steering shaft 203 so that the driver can feel a steering reaction force in the opposite direction in a case where the driver operates the steering wheel 201, and during autonomous driving, steering is performed by the control of the electronic control device 210 without the intervention of the driver's will.

The pinion shaft motor 225 slides the rack bar 211 connected to a pinion shaft 213 to steer wheels 219 on both sides through a tie rod 215 and a knuckle arm 217.

However, for convenience of explanation, the drawings in the present embodiments illustrate an example in which the angle sensor 205 and the torque sensor 207 provided in the steering shaft 203, a vehicle speed sensor 202 for transmitting steering information to the electronic control device 210, a pinion shaft rotation angle sensor 204, an ultrasonic sensor 206, and an image sensor 208 are provided, but in addition, a motor position sensor, various types of radars and lidars, or the like may be provided, and a detailed description thereof will be omitted below.

In the steer by wire type steering apparatus, since the steering wheel 201 and the wheel 219 are not mechanically connected, a mechanical restriction is required to stop the rotation of the steering wheel 201 at a certain angle in a case where the driver operates the steering wheel 201.

That is, in a case where the rotation of the wheel 219 reaches its maximum point (in a typical steering apparatus, in a case where the steering wheel 201 or the wheel 219 is in a full-turn state), a rotation angle limiting member 240 is provided to mechanically limit the rotation angle of the steering shaft 203 so that the steering wheel 201 does not rotate any further, thereby providing the driver with an accurate steering feel.

The rotation angle limiting member 240 is provided at the lower end portion of a steering column (not illustrated) and is coupled to the housing 110 together with the steering shaft motor 220, the reducer 103, or the like.

In the present embodiments, the reducer 103 includes a worm shaft that is connected to the steering shaft motor 220 and rotated, a worm wheel that is coupled to the steering shaft 203 and rotates by the worm shaft, or the like, and the rotation of the motor may be reduced by a gear ratio of the worm shaft and the worm wheel.

The rotation angle limiting member 240 includes the first rotation ring member 140 that is coupled to the steering shaft 203 and rotates in conjunction with the steering shaft 203, the second rotating ring member 160 that is coupled to the steering shaft 203 and supported by one end portion of the first rotating ring member 140 in a case where the steering shaft 203 rotates, and rotates in conjunction with the first rotating ring member 140, the housing 110 that is provided with the arc-shaped guide groove 111 centered on the steering shaft 203 and the stopper partition 112 that connects the radially inner and outer surfaces of the guide groove 111, the stopper member 130 that is coupled to the guide groove 111 and is supported by one end portion of the second rotation ring member 160 and rotates in a case where the steering shaft 203 rotates, a rotating ring fixing member 105 that is coupled to the steering shaft 203 and fixes the axial positions of the first rotation ring member 140 and the second rotating ring member 160, or the like.

An upper surface 110T of the housing 110 is formed as a plane perpendicular to the steering shaft 203, and the housing 110 includes the arc-shaped guide groove 111 centered on the steering shaft 203 and the stopper partition 112 connecting the inner and outer surfaces of the guide groove 111.

The stopper member 130 is coupled to the guide groove 111, and in a case where the steering shaft 203 rotates, one end portion of the second rotating ring member 160 is supported by the stopper member 130, and the rotation angles of the first rotating ring member 140 and the second rotating ring member 160 are limited.

The first rotating ring member 140 that is coupled to the steering shaft 203 and rotates in conjunction with the steering shaft 203 includes a ring-shaped first shaft coupling portion 141 having a first coupling hole 142 to which the steering shaft 203 is coupled, and an extension support portion 147 that extends radially from the outer peripheral surface of the first shaft coupling portion 141 and is supported by the second rotating ring member 160.

In these embodiments, the first shaft coupling portion 141 and the extension support portion 147 are illustrated as being formed integrally as an example, but the present disclosure is not necessarily limited thereto, and the first shaft coupling portion 141 and the extension support portion 147 may be formed separately and then coupled.

On the inner peripheral surface of the first coupling hole 142, a plurality of inner peripheral serrations 143 is formed long in the axial direction, and on the outer peripheral surface of the steering shaft 203 inserted into and coupled to the first coupling hole 142, an outer peripheral serration 101a that interlocks with the inner peripheral serrations 143 is provided long in the axial direction.

Accordingly, in a case where the steering shaft 203 rotates, the first rotating ring member 140 may rotate in conjunction with the steering shaft 203 without spinning.

The second rotating ring member 160 may include a second shaft coupling portion 161 having a second coupling hole 162 to which the steering shaft 203 is coupled, and a stopper support portion 167 that extends radially from the outer peripheral surface of the second shaft coupling portion 161 and protrudes axially and is supported by the extension support portion 147.

An elastic member 166 that supports the stopper member 130 may be coupled to the stopper support portion 167 of the second rotating ring member 160, and a fixing groove 169 to which the elastic member 166 is coupled may be provided on the outer peripheral surface of the stopper support portion 167.

In addition, the extension support portion 147 is formed with a width reduced by cutting both sides in the circumferential direction on the lower surface facing the stopper support portion 167, and a support groove 149 is formed to support the elastic member 166 in a case where the first rotating ring member 140 rotates.

Accordingly, in a case where the second rotating ring member 160 is supported by the first rotating ring member 140 and rotates and is supported by the stopper member 130, the elastic member 166 may be supported while reducing shock and noise.

The guide groove 111 provided in the housing 110 may include a first guide groove 111a formed vertically on the upper surface 110T of the housing 110, as illustrated in FIG. 9, and a second guide groove 111b recessed radially inward on the lower surface of the first guide groove 111a and connected to the first guide groove 111a.

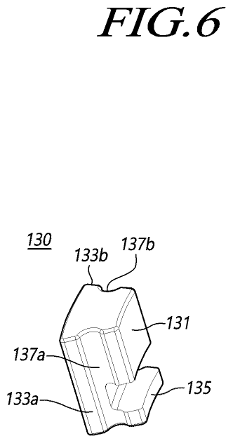

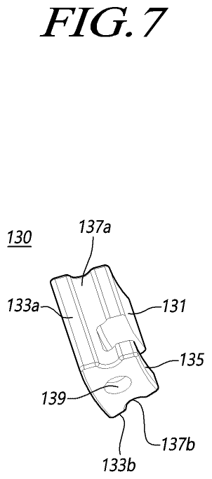

Moreover, referring to FIGS. 6 and 7 together with FIG. 9, the stopper member 130 includes a first support portion 131 supported by the upper surface 110T of the housing 110, and a second support portion 135 whose outer surface is supported by the outer surface of the first guide groove 111a and whose inner surface is axially spaced from the first support portion 131 and is inserted into and supported by the second guide groove 111b.

Accordingly, in a case where the second rotating ring member 160 supports and rotates the stopper member 130, the first support portion 131 supports the upper surface 110T of the housing 110 and the second support portion 135 supports the second guide groove 111b to rotate, so that the stopper member 130 may move to a fixed position without being detached.

On both sides of the outer end of the stopper member 130, partition support portions 133a and 133b supported by one side and the other side of the stopper partition 112 are provided.

In addition, seating grooves 137a and 137b by which the elastic member 166 is supported in a case where the second rotating ring member 160 rotates may be provided on both side surfaces of the stopper member 130.

Accordingly, in a case where the second rotating ring member 160 rotates and is supported by the stopper member 130, the stopper member 130 is supported at an accurate position, so that the rotation of the stopper member 130 may be accurately achieved.

In addition, the first guide groove 11a is provided with an extension groove 121 that extends radially outward, and a cap member 120 that supports the outer surface of the stopper member 130 in the radial direction may be coupled to the extension groove 121.

Accordingly, in a case where the stopper member 130 is assembled to the guide groove 111, the stopper member 130 is assembled to the first guide groove 111a and the second guide groove 111b through the extension groove 121, and in a case where the assembly is completed, the cap member 120 is coupled to the extension groove 121, thereby facilitating the assembly of the stopper member 130 while preventing the stopper member 130 from being detached.

Additionally, an insertion member 125 that axially supports the stopper member 130 may be coupled between the stopper member 130 and the bottom surface of the first guide groove 111a.

That is, as illustrated in FIG. 9, the insertion member 125 is compressed and coupled between the stopper member 130 and the bottom surface of the first guide groove 111a so as to absorb the gap between the second support portion 135 and the bottom surface of the first guide groove 111a, thereby supporting the stopper member 130 in the axial direction.

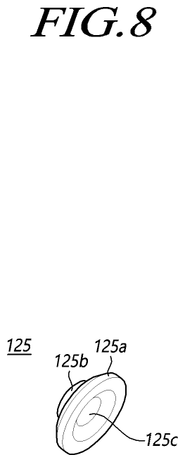

Moreover, as illustrated in FIGS. 7 and 8, an insertion groove 139 is formed on the lower surface of the stopper member 130, and an insertion protrusion 125b that is coupled to the insertion groove 139 is provided on the upper side of the insertion member 125, so that the insertion member 125 may axially support the stopper member 130 at an accurate position.

In addition, a lower surface of a body 125a of the insertion member 125 is provided with a bottom groove 125c so that axial elastic deformation can be easily achieved, so that the insertion member 125 is compressed and coupled between the stopper member 130 and the bottom surface of the first guide groove 111a.

In addition, the present embodiments may further include a rotating ring support member 170 that is coupled between the second coupling hole 162 of the second shaft coupling portion 161 and the outer peripheral surface of the steering shaft 203 and is axially supported by the first shaft coupling portion 141 of the first rotating ring member 140.

As illustrated in FIG. 5, the rotating ring support member 170 is formed in a ring shape with one side cut off and has an outer peripheral groove 179 provided on the outer peripheral surface so that the inner surface of the second coupling hole 162 is seated and coupled.

In addition, since one side of the rotating ring support member 170 is cut, the rotating ring support member 170 is easily elastically deformed during assembly, making assembly easier, and after assembly, the second rotating ring member 160 is secured on the outer peripheral groove 179, so that an accurate assembly position may be maintained.

The rotating ring support member 170 has an outer support portion 171 formed on the radially outer side of a circumferential groove 177 formed in a circumferential direction at an outer end portion thereof, and an inner support portion 173 formed on the radially inner side of the circumferential groove. The inner support portion 173 has a cut groove 173a cut from the outer end of the inner support portion 173 to the bottom surface of the circumferential groove 177, and one or more cut grooves 173a may be disposed.

Accordingly, the rotating ring support member 170 is easily elastically deformed in the axial and radial directions to support the second rotating ring member 160, so that the second rotating ring member 160 does not rotate freely but is supported by the first rotating ring member 140 in the assembled position and can rotate.

In addition, a radially protruding support protrusion 175 is formed on the inner peripheral surface of the inner support member 173, and an annular protrusion-coupling groove 175a to which the support protrusion 175 is coupled is formed on the outer peripheral surface of the steering shaft 203.

Therefore, in a case where the rotating ring support member 170 and the steering shaft 203 are assembled, the axial gap is reduced and the frictional force in the circumferential direction is reduced.

A receiving groove 141a in which an outer support portion 171 and an inner support portion 173 are seated and supported is provided on the lower side of the first shaft coupling portion 141, so that the first rotating ring member 140 supports the rotating ring support member 170 in the axial direction by the tightening force of the rotating ring fixing member 105.

The operating mechanism of these embodiments is explained below with reference to FIG. 2 and FIG. 9.

For convenience of explanation, FIGS. 2 and 9 illustrate a state in which the stopper member is not supported by the second rotating ring member, and FIG. 9 illustrates a cross-sectional view of FIG. 2.

In the state of FIG. 2, in a case where the driver turns the steering wheel clockwise, the right end of the first rotating ring member is supported by the left end of the second rotating ring member and rotates together, and as the clockwise rotation progresses, the right end of the second rotating ring member is supported by the stopper member and rotates the stopper member clockwise.

After this, the stopper member 130 is supported by the left side of the stopper partition 112 to stop rotation, and at the same time, the rotations of the first rotating ring member 140 and the second rotating ring member are also limited, so that the driver may detect that the steering wheel has been fully turned clockwise.

Thereafter, in a case where the driver turns the steering wheel counterclockwise, the first rotating ring member 140 rotates counterclockwise, and the left end of the first rotating ring member is supported by the right end of the second rotating ring member and rotates together. As the counterclockwise rotation progresses, the left end of the second rotating ring member is supported by the stopper member and rotates the stopper member counterclockwise.

After this, the stopper member 130 is supported by the right side of the stopper partition 112 to stop rotation, and at the same time, the rotations of the first rotating ring member 140 and the second rotating ring member are also limited, so that the driver may detect that the steering wheel has been fully turned counterclockwise.

In addition, referring to FIGS. 9 to 13 together with FIGS. 1 to 8, the steer by wire type steering apparatus according to the present embodiments includes the first rotating ring member 140 that is coupled to the steering shaft 203 and rotates in conjunction with the steering shaft 203, the second rotating ring member 160 that is coupled to the steering shaft 203 and supported by one end portion of the first rotating ring member 140 in a case where the steering shaft 203 rotates and rotates in conjunction with the first rotating ring member 140, the housing 110 that is provided with an arc-shaped stepped groove 114 centered on the steering shaft 203 and the stopper partition 112 that connects the radially inner and outer surfaces of the stepped groove 114, a guide member 150 that is formed in an arc shape and has one end and the other end supporting both surfaces of the stopper partition 112 and is coupled to the stepped groove 114, and a stopper member 130 that is coupled to the guide member 150 and is supported by one end portion of the second rotating ring member 160 and rotates in a case where the steering shaft 203 rotates.

In addition, the present embodiments may further include the rotating ring fixing member 105 coupled to the steering shaft 203 to axially support the first rotating ring member 140 and the second rotating ring member 160.

The stopper member 130 is coupled to the guide member 150, and in a case where the steering shaft 203 rotates, one end portion of the second rotating ring member 160 rotates the stopper member 130, and the stopper member 130 is supported by the stopper partition 112, so that the rotation angles of the first rotating ring member 140 and the second rotating ring member 160 are limited.

The first rotating ring member 140 may include the ring-shaped first shaft coupling portion 141 having the first coupling hole 142 to which the steering shaft 203 is coupled, and the extension support portion 147 that extends radially from the outer peripheral surface of the first shaft coupling portion 141 and is supported by the stopper member 130.

The second rotating ring member 160 may include the second shaft coupling portion 161 having the second coupling hole 162 to which the steering shaft 203 is coupled, and the stopper support portion 167 that extends radially from the outer peripheral surface of the second shaft coupling portion 161 and protrudes axially and is supported by the extension support portion 147.

The rotating ring fixing member 105, the first rotating ring member 140, the second rotating ring member 160, the stopper member 130, and the rotating ring support member 170 illustrated in FIGS. 10 to 13 are the same as those illustrated in FIGS. 1 to 9, so detailed descriptions thereof will be omitted below.

As illustrated in FIGS. 11 and 13, the stepped groove 114 may include a first stepped groove 114a which is formed vertically stepwise on the upper surface 110T of the housing 110 and to which the guide member 150 is coupled, and a second stepped groove 114b formed vertically stepwise and recessed on a step surface extending radially outward from the lower surface of the first stepped groove 114a.

The guide member 150 is formed in an arc shape with a cut portion 151 on one side, as illustrated in FIG. 12, and is formed to a certain thickness and is pressed into and coupled to the first stepped groove 114a.

Moreover, the stopper member 130 is coupled to the outer periphery side of the guide member 150 and inserted into the first stepped groove 114a and the second stepped groove 114b, and rotation is performed along the outer peripheral surface of the guide member 150.

The stopper member 130 may include the first support portion 131 supported by the upper surface of the guide member 150, and the second support portion 135 whose outer surface is supported by the outer surface of the second stepped groove 114b and whose inner surface is axially spaced from the first support portion 131 and supported by the lower surface of the guide member 150.

Accordingly, in a case where the second rotating ring member 160 supports and rotates the stopper member 130, the first support portion 131 supports the upper surface of the guide member 150 and the second support portion 135 supports the second stepped groove 114b to rotate, so that the stopper member 130 may move to a fixed position without being detached.

The seating grooves 137a and 137b by which the elastic member 166 is supported in a case where the second rotating ring member 160 rotates may be provided on both side surfaces of the stopper member 130.

Accordingly, in a case where the second rotating ring member 160 rotates and is supported by the stopper member 130, the stopper member 130 is supported at an accurate position, so that the rotation of the stopper member 130 may be accurately achieved.

The insertion member 125 that axially supports the stopper member 130 may be coupled between the stopper member 130 and the bottom surface of the second stepped groove 114b.

That is, as illustrated in FIG. 13, the insertion member 125 is compressed and coupled between the stopper member 130 and the bottom surface of the second stepped groove 114b so as to absorb the gap between the second support portion 135 and the bottom surface of the guide member 150, thereby supporting the stopper member 130 in the axial direction.

Moreover, as illustrated in FIGS. 7 and 8, the insertion groove 139 is formed on the lower surface of the stopper member 130, and an insertion protrusion 125b that is coupled to the insertion groove 139 is provided on the upper side of the insertion member 125, so that the insertion member 125 may axially support the stopper member 130 at an accurate position.

In addition, the lower surface of the insertion member 125 is provided with the bottom groove 125c so that axial elastic deformation can be easily achieved, so that the insertion member 125 is compressed and coupled between the stopper member 130 and the bottom surface of the second stepped groove 114b.

As described above, according to these embodiments, in a case where the rotation of the wheel in the steer by wire type steering apparatus reaches the maximum point, the steering wheel is mechanically prevented from rotating any further, thereby improving the steering feel and steering safety of the driver.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments illustrated, but is to be accorded with the widest scope consistent with the claims.

What is claimed is:

1. A steer by wire type steering apparatus comprising:
a first rotating ring member that is coupled to a steering shaft and rotates in conjunction with the steering shaft;
a second rotating ring member that is coupled to the steering shaft and supported by one end portion of the first rotating ring member in a case where the steering shaft rotates and rotates in conjunction with the first rotating ring member;
a housing that is provided with an arc-shaped guide groove centered on the steering shaft and a stopper partition that connects radially inner and outer surfaces of the guide groove; and
a stopper member that is coupled to the guide groove and is supported by one end portion of the second rotating ring member and rotates in a case where the steering shaft rotates.

2. The steer by wire type steering apparatus of claim 1, wherein the first rotating ring member includes
a first shaft coupling portion having a first coupling hole to which the steering shaft is coupled, and
an extension support portion extending radially from an outer peripheral surface of the first shaft coupling portion and supported by the second rotating ring member.

3. The steer by wire type steering apparatus of claim 2, wherein the second rotating ring member includes
a second shaft coupling portion having a second coupling hole to which the steering shaft is coupled, and
a stopper support portion extending radially from an outer peripheral surface of the second shaft coupling portion and protruding axially and supported by the extension support portion.

4. The steer by wire type steering apparatus of claim 2, wherein the guide groove includes
a first guide groove formed vertically on an upper surface of the housing, and
a second guide groove recessed radially inward on a lower surface of the first guide groove and connected to the first guide groove.

5. The steer by wire type steering apparatus of claim 4, wherein the stopper member includes
a first support portion supported by the upper surface of the housing, and
a second support portion whose outer surface is supported by an outer surface of the first guide groove and whose inner surface is axially spaced from the first support portion and is inserted into and supported by the second guide groove.

6. The steer by wire type steering apparatus of claim 4, wherein the stopper member has seating grooves on both side surfaces by which an elastic member coupled to the stopper support member is supported.

7. The steer by wire type steering apparatus of claim 4, wherein the first guide groove is provided with an extension groove extending radially outward, and a cap member that supports an outer surface of the stopper member radially is coupled to the extension groove.

8. The steer by wire type steering apparatus of claim 4, wherein an insertion member that axially supports the stopper member is coupled between the stopper member and a bottom surface of the first guide groove.

9. The steer by wire type steering apparatus of claim 3, further comprising a rotating ring support member coupled between the second coupling hole of the second shaft coupling portion and an outer peripheral surface of the steering shaft and axially supported by the first shaft coupling portion.

10. The steer by wire type steering apparatus of claim 9, wherein the rotating ring support member is formed in a ring shape with one side cut off and has an outer peripheral groove on which an inner surface of the second coupling hole is seated on an outer peripheral surface.

11. The steer by wire type steering apparatus of claim 10, wherein the rotating ring support member has an outer support portion formed on a radially outer side of a circumferential groove formed in a circumferential direction and an inner support portion formed on a radially inner side of the circumferential groove.

12. A steer by wire type steering apparatus comprising:
a first rotating ring member that is coupled to a steering shaft and rotates in conjunction with the steering shaft;
a second rotating ring member that is coupled to the steering shaft and supported by one end portion of the first rotating ring member in a case where the steering shaft rotates and rotates in conjunction with the first rotating ring member;
a housing that is provided with an arc-shaped stepped groove centered on the steering shaft and a stopper partition that connects radially inner and outer surfaces of the stepped groove;
a guide member that is formed in an arc shape and has one end and the other end supporting both surfaces of the stopper partition and is coupled to the stepped groove; and
a stopper member that is coupled to the guide member and is supported by one end portion of the second rotating ring member and rotates in a case where the steering shaft rotates.

13. The steer by wire type steering apparatus of claim 12, wherein the first rotating ring member includes
a first shaft coupling portion having a first coupling hole to which the steering shaft is coupled, and
an extension support portion extending radially from an outer peripheral surface of the first shaft coupling portion and supported by the second rotating ring member.

14. The steer by wire type steering apparatus of claim 13, wherein the second rotating ring member includes
a second shaft coupling portion having a second coupling hole to which the steering shaft is coupled, and
a stopper support portion extending radially from an outer peripheral surface of the second shaft coupling portion and protruding axially and supported by the extension support portion.

15. The steer by wire type steering apparatus of claim 13, wherein the stepped groove includes
a first stepped groove which is formed vertically on an upper surface of the housing and to which the guide member is coupled, and
a second stepped groove formed vertically recessed on a step surface extending radially outward from a lower surface of the first stepped groove.

16. The steer by wire type steering apparatus of claim 15, wherein the stopper member includes
a first support portion supported by an upper surface of the guide member, and
a second support portion whose outer surface is supported by an outer surface of the second stepped groove and whose inner surface is axially spaced from the first support portion and supported by a lower surface of the guide member.

17. The steer by wire type steering apparatus of claim 15, wherein the stopper member has seating grooves on both side surfaces by which an elastic member coupled to the stopper support member is supported.

18. The steer by wire type steering apparatus of claim 15, wherein an insertion member that axially supports the stopper member is coupled between the stopper member and a bottom surface of the second stepped groove.

19. The steer by wire type steering apparatus of claim 14, further comprising a rotating ring support member coupled between the second coupling hole of the second shaft coupling portion and an outer peripheral surface of the steering shaft and axially supported by the first shaft coupling portion.

20. The steer by wire type steering apparatus of claim 19, wherein the rotating ring support member is formed in a ring shape with one side cut off and has an outer peripheral 10 groove on which an inner surface of the second coupling hole is seated on an outer peripheral surface.
